(19) United States
(12) Patent Application Publication
(10) Pub. No.: US 2014/0246415 A1
(43) Pub. Date: Sep. 4, 2014

(54) ELECTRICALLY CONDUCTIVE TEXTILES FOR OCCUPANT SENSING AND/OR HEATING APPLICATIONS

(71) Applicant: IEE INTERNATIONAL ELECTRONICS & ENGINEERING S.A., Echternach (LU)

(72) Inventor: Thomas Wittkowski, Hermeskeil (DE)

(73) Assignee: IEE INTERNATIONAL ELECTRONICS & ENGINEERING S.A., Echternach (LU)

(21) Appl. No.: 14/349,717

(22) PCT Filed: Oct. 8, 2012
(86) PCT No.: PCT/EP2012/069903

§ 371 Date: Apr. 4, 2014

(30) Foreign Application Priority Data
Oct. 6, 2011 (LU) 91 881

(51) Int. Cl. H05B 3/02

(52) U.S. Cl. CPC H05B 3/02
USPC 219/201

(57) ABSTRACT

A flexible heater and/or electrode comprises a woven textile material having a warp direction and a weft direction, said textile material comprising at least one region having a low electrical conductance and at least two regions having a high electrical conductance. The at least two regions of high electrical conductance are adjacent to said at least one region of low electrical conductance. At least one of said at least two regions of high electrical conductance is operatively connected to a connection terminal of said heater and/or electrode, said connection terminal for connecting said heater and/or electrode to an electronic control circuit.

### TECHNICAL FIELD

The present invention generally relates to electrically conductive textiles which may be used e.g. for occupant sensing and/or heating in vehicles. The invention more particularly relates to textile based electrode elements for occupant detection systems (ODS), an occupant classification systems (OCS) and/or occupant heating to be integrated in dedicated surfaces of the vehicle passenger compartment.

### BACKGROUND ART

It is well known nowadays to equip automotive vehicles with comfort related functional components such as heaters (for seating area heating, backrest heating, arm-rest heating, steering wheel heating, gearshift lever heating, or heating of other interior surface areas) or with safety related components such as occupant detection or classification systems for use in the control of secondary restraint systems such as airbags or seat belt pretensioners or other safety systems (like driver surveillance or life sign monitoring). The seat heaters and the occupant detection or classification systems both use electrode elements which are arranged in the vehicle in close vicinity to the occupant within the passenger compartment. Usually these electrode elements, such as seat heating mats or sensor electrodes are to be arranged into the seating surface of the occupant seat and/or into other surfaces of the vehicle interior compartment, which under normal conditions are in contact with or proximate to the occupant, such as in the seat surface area, the seat backrest, an armrest, the steering wheel, the gearshift lever, doors, or other surface areas. In order to hide the electrode elements for the occupant, the electrode elements are normally arranged below a seat trim or below a covering of other surfaces delimiting the vehicle passenger compartment.

As the electrode components or elements should not impair the comfort of the passenger it is important that the electrode elements cannot be sensed below the trim or covering by the occupant. For this reason, the electrode element should be highly flexible and, especially if integrated into the seating surface of a vehicle seat, highly permeable to air and humidity. Accordingly recent developments tend to provide these electrode elements as conductive textile components, which may easily fulfill the above mentioned requirements.

Textile based occupant detection systems or occupant classification systems are designed to be fully functional over a vehicles lifetime, which is at least 15 years. Seat heaters, however, are frequently failing after only a few years of operation. Today's concept of constructing and producing seat heaters including their material concepts severely limit their robustness. Hence today's way of producing seat heaters cannot be transferred to producing textile sensor electrodes for safety relevant applications such as occupant detection systems or occupant classification systems.

Today electrical conductance for the purpose of seat heating with textile materials in vehicles is mostly obtained by copper wiring or carbon fibers integrated into the textile material. These materials are inherently brittle and wires/fibers are prone to breakage. They pose a potential lack of comfort or even the danger of injuring passengers if conductive wires should break. Hence such systems exhibit severe limitations for the production of combined seat occupation sensing and heating or even for heating alone, if automotive lifetime requirements are 15 years and more.

Copper wiring for serial heating is often applied by embroidery on a supporting textile. Carbon fibers often require complex techniques for attaching them to a supporting textile. Such techniques are lacking the freedom of design because the geometrical extensions (size of the heater, e.g.) are too strongly related with the electrical properties of the system. Systems are sought for where geometrical and electrical target values are largely independent and can be easily achieved.

Integration of a sensor or heater into the automotive interior needs to be as easy as possible. Most sensor or heaters today cannot be sewn to a support because this process would harm their electrical properties too much. Textile sensing and heating solutions are sought that can be easily integrated, e.g. that can be sewn into the trim of a vehicle seat. In summary the problems to be solved are lack of stability, lack of comfort, design deficiencies, and difficulties with the integration of textile automotive sensors and heaters.

Today occupant sensing and heating are provided with different products: with occupant sensors that often work according to a capacitive measurement principle, and with separate heaters. Occupant sensing systems possess lifetimes of more than 15 years whereas the lifetime of a heater is often shorter, typically a few years only. Sensors and heaters can both be successfully integrated in vehicle seats but as separate systems.

Textiles possess favorable characteristics for automotive application such as air permeability, resilience, pliancy, and low price. Textile occupant sensing and textile heating are about to increase their market share. Again, there are no systems available that could provide occupant sensing and heating integrated in one textile over a lifetime of 15 years +.

The textile heating systems currently available on the market exhibit characteristic deficiencies which are related to the materials and techniques used to design and produce such heaters. Sensors or heaters that are sewn into a flexible support like the trim of a vehicle seat, e.g., are not present in the market.

Copper based wiring for serial heating is often applied by embroidery on a supporting textile. Carbon fibers often require complex techniques for attaching/integrating them to a textile. Those conducting materials are prone to breakage thus bearing significant risks regarding comfort and safety. Such techniques are lacking the freedom of design because the geometrical dimensions (size of the heater, e.g.) are too strongly related with the thermo-electrical properties of the system.

### BRIEF SUMMARY

An improved electrically conductive textile material for occupant sensing and/or heating applications is provided.

More particularly, the invention discloses a textile sensor and/or heater material suitable for providing occupant sensing (classification or detection) in a vehicle, heating or heating and occupant sensing. The textile sensors and/or heaters are characterized by a lifetime in the vehicle of at least 15 years. In order to achieve this goal, the present invention proposes the use of electrically conductive materials such as yarns and inks, which are inherently flexible and long-term stable. Textiles are woven that comprise conductive yarns and that are optionally overprinted s0 that the resulting sensor and/or heater textile is resilient, pliant, air permeable, and cheap.

This becomes possible by implementing areas of different conductance into the textile. Such areas are technically obtained either by the weaving process or by combination of weaving and a printing process. For heating, the processes of weaving and/or printing allow to fulfill three conditions that relate to electrical and geometrical parameters of a heating element. The resulting sensor and/or heater textile yields a maximum of passenger comfort and operational safety. Due to its inherent robustness and its variability in design it can be easily integrated at any place in a vehicle compartment.

In accordance with a first aspect of the present invention, a flexible heater and/or electrode comprises a woven textile material having a warp direction and a weft direction, said textile material comprising at least one region having a low electrical conductance and at least two regions having a high electrical conductance. Said at least two regions of high electrical conductance are arranged and preferably extend adjacent to said at least one region of low electrical conductance. At least one of said at least two regions of high electrical conductance is operatively connected to a connection terminal of said heater and/or electrode, said connection terminal for connecting said heater and/or electrode to an electronic control circuit.

In a preferred embodiment of the invention, said at least one region having a low electrical conductance is provided by the use of electrically conductive weft and/or warp yarns in a suitable thread density. Alternatively or additionally said at least one region having a low electrical conductance is provided by applying, preferably printing, a low conductivity material onto a woven textile made of non-conductive yarns or of low conductance yarns.

In a possible embodiment of the invention at least one of said at least two regions of high electrical conductance is provided by the use of high conductance weft or warp yarns. Alternatively or additionally at least one of said at least two regions of high electrical conductance is provided by applying, preferably printing, a high conductivity material adjacent to said at least one region having a low electrical conductance onto a woven textile made of non-conductive yarns or of low conductance yarns.

According to one embodiment, a first one of said at least two regions of high electrical conductance extends in warp direction adjacent at least one region having a low electrical conductance, and a second one of said at least two regions of high electrical conductance extends in warp direction adjacent at least one region having a low electrical conductance, said first one and said second one of said at least two regions of high electrical conductance intersecting at least in one crossing point. In order to improve the electrical contact between said regions of high electrical conductance, a high conductivity material is preferably applied, e.g. printed, onto said first one and said second one of said at least two regions of high electrical conductance in the area of said crossing point.

According to another embodiment, a first one and a second one of said at least two regions of high electrical conductance both extend in warp direction or in weft direction adjacent opposing sides of said at least one region having a low electrical conductance and both the first one and the second one of said at least two regions of high electrical conductance are operatively connected to connection terminals of said heater and/or electrode, said connection terminals for connecting said heater and/or electrode to an electronic control circuit.

Depending on the configuration of the heater or electrode, said at least one region having a low electrical conductance may be configured to have anisotropic conductance properties, preferably different electronic properties in weft and warp directions.

The present invention also relates to a heating installation comprising a flexible heater and/or electrode as disclosed above, and an electronic control unit for supplying said flexible heater with a heating current. In a possible embodiment, the heater installation comprises a number of heater elements and an electronic control unit for supplying said heater elements with a heating current, each of said heater elements comprising a flexible heater and/or electrode as described above.

In a possible variant of this embodiment, the regions of low electrical conductance of the individual heater elements have different electrical properties, such as different sheet resistance Rsqⱼ. The individual heater elements are preferably arranged in a sequence in such a way that the individual sheet resistances Rsqⱼ of the regions of low conductance decrease with increasing distance from said connection terminal.

In a further possible embodiment, the respective ones of the at least two regions of high electrical conductance of the individual heater elements are arranged in mutual alignment and interconnected so as to form a common feed line for the individual regions of low conductance.

The present invention also relates to a sensing installation comprising a flexible heater and/or electrode as described herein above, and an electronic control unit for supplying said flexible heater and/or electrode with a sensing voltage or current.

### BRIEF DESCRIPTION OF THE DRAWINGS

Further details and advantages of the present invention will be apparent from the following detailed description of several not limiting embodiments with reference to the attached drawings.

### DESCRIPTION OF PREFERRED EMBODIMENTS

Textile electrode and/or heating textile are integrated in the vehicle compartment, preferably the sensor and/or heater is attached from the backside to a surface such as driver seat, passenger seat, backseat, steering wheel, door side of compartment, gear shift lever, etc.

The present invention discloses how to design and produce a textile electrode for an occupant detection or classification system or a heating textile or a textile that exhibits hybrid functionality, i.e. which can be used for sensing and heating.

All materials used to produce such textile and to provide electrical conductance are characterized by only a small change in their relevant properties if exposed to environmental and mechanical stresses as they occur over vehicle lifetime. So the materials themselves need to be resilient, flexible, and to some extent chemically inert. In particular their electromechanical properties are allowed to vary only in a small range upon application of mechanical stresses, after cyclic bending load or after exposure to high humidity, high temperature or certain chemical substances.

The conductive textile, which is prepared from those materials, has characteristic properties making it excellently suitable for sensing and heating in the automotive. The textile is resilient, pliant, air permeable, printable, mechanically robust, and environmentally robust. In addition it is of comparatively low price because yarns, weaving techniques, inks, printing techniques, etc. base on mass products, respectively fully automated, large volume technical processes.

An important aspect of the invention relates to the way how structured electrical conductance is integrated in a textile and how it is combined with a structured deposition technique, namely printing of conductive ink. When combining both techniques correctly, i.e. when choosing the correct materials and techniques, and when applying strict design criteria, the resulting sensor electrode and/or heater does perform in a manner that qualifies it for automotive sensing and/or heating applications with a lifetime of more than 15 years.

### DEFINITIONS

Yarn: Different types of yarns are typically used to weave the textile: (non-conductive) pure polymer yarn, pure metal yarn (spun yarn or continuous filament yarn), blended spun yarn (PET with steel, e.g.), blended continuous yarn (PET with steel, e.g.). Conductive filaments of a yarn may comprise full metal, e.g. of steel, or they may comprise coated polymer filaments, e.g. coated with silver or steel or they may comprise metal filaments (e.g. copper or steel) that are coated or clad with another metal (e.g. steel or copper). Leno threads may be made of conductive or of non-conductive mono- or multifilament yarn of whatever type.
High conductance yarn: Resistance per length unit, R/a, is typically between 0.1 and 100 Ohm/m.
Low conductance yarn: Resistance per length unit, R/a, is typically between 10² and 10⁵ Ohm/m
Non-conductive yarn: Resistance per length unit, R/a>10⁶ Ohm/m. Yarn is pure polymer yarn, typically.
Raw textile: The raw textile is preferably a weave where different degrees of conductance (line conductance, sheet conductance) are implemented by the use of conductive yarns. The raw textile can possess areas of different conductance. Conductance of a raw textile area is determined by the yarns used, number of threads per length unit, and weaving design. In order to make the raw textile air permeable it is favorable to adjust a certain clearance between neighboring threads. In order to prevent threads from shifting, a Leno weaving technique is advantageous in which crossing threads are pressed together and thus protected against shifting or slipping. This technique is also helpful but not necessary in order to minimize the contact resistance between crossing threads.
Printing: Technique to apply functional materials (inks) in liquid form onto a textile substrate. The liquid ink is subsequently solidified on the textile substrate. Printing techniques are flat bed screen printing, rotary screen printing, flexographic printing, gravure printing, offset printing, inkjet printing. In the present invention rotary screen printing is most favorable.
High conductivity ink: Ink whose conductivity in solidified form typically ranges between 5*10⁵ and 5*10⁷ S/m.
Low conductivity ink: Ink whose conductivity in solidified form typically lies between 10⁻¹ and 10⁴ S/m. Such inks typically contain carbon black, graphite or carbon nanotubes as conductive particles and a soft polymer as binder. Alternative conductive fillers such as conductive polymers or mixtures of carbon black, graphite and silver particles are possible. In solidified state the low conductivity ink may possess a characteristic dependence of its resistivity as a function of temperature. Particularly desirable are inks with a resistivity that exhibit a positive temperature coefficient (PTC) so that the heating power at elevated temperature becomes limited. A resistance ratio R(T=358 K)/R(T=293 K)≈10 is desirable.
Printed textile: Raw textile that is overprinted in defined regions with high conductivity ink or low conductivity ink.
Area of high conductance: Length in one planar direction>>length in perpendicular planar direction. Resistance per length unit measured in the long direction, Rᵢ/a, is typically between 0.01 and 10 Ohm/m. Index i denotes the i-th area of high conductance.
Area of low conductance: conductive textile sheet material with sheet resistance, Rsqⱼ, typically between 10 Ohm and 10 kOhm. Index j denotes the j-th area of low conductance.

A. Textile Electrode for Occupant Detection or Classification

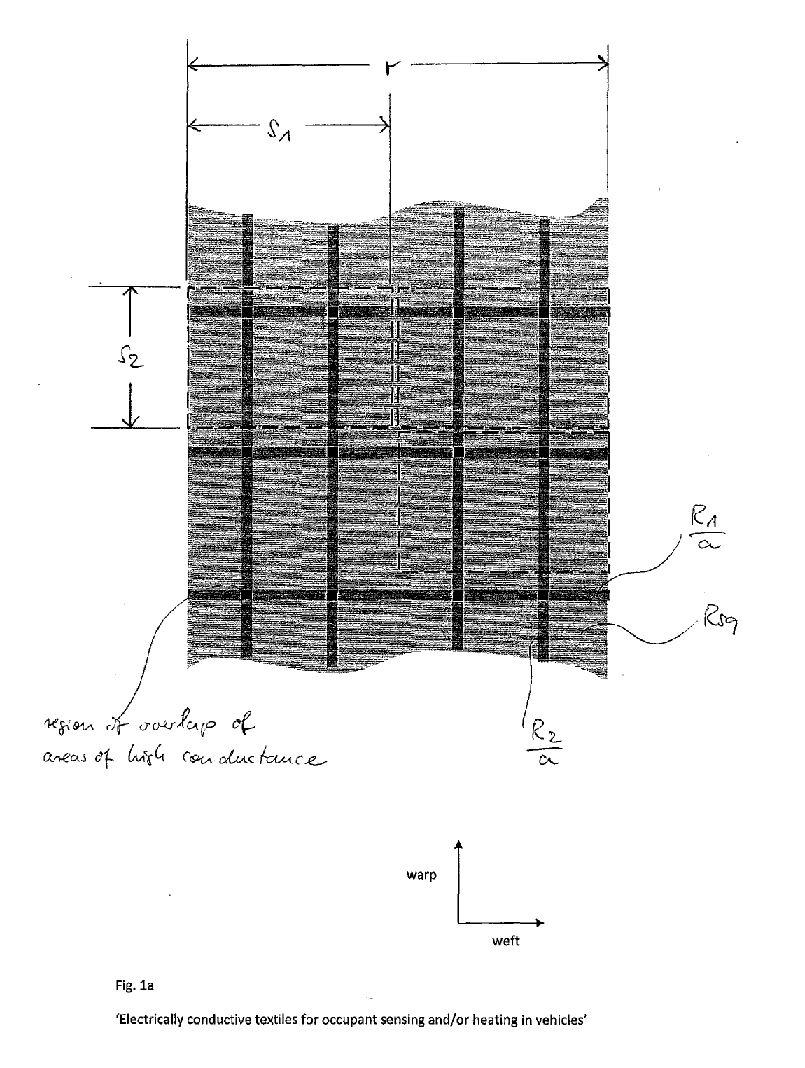

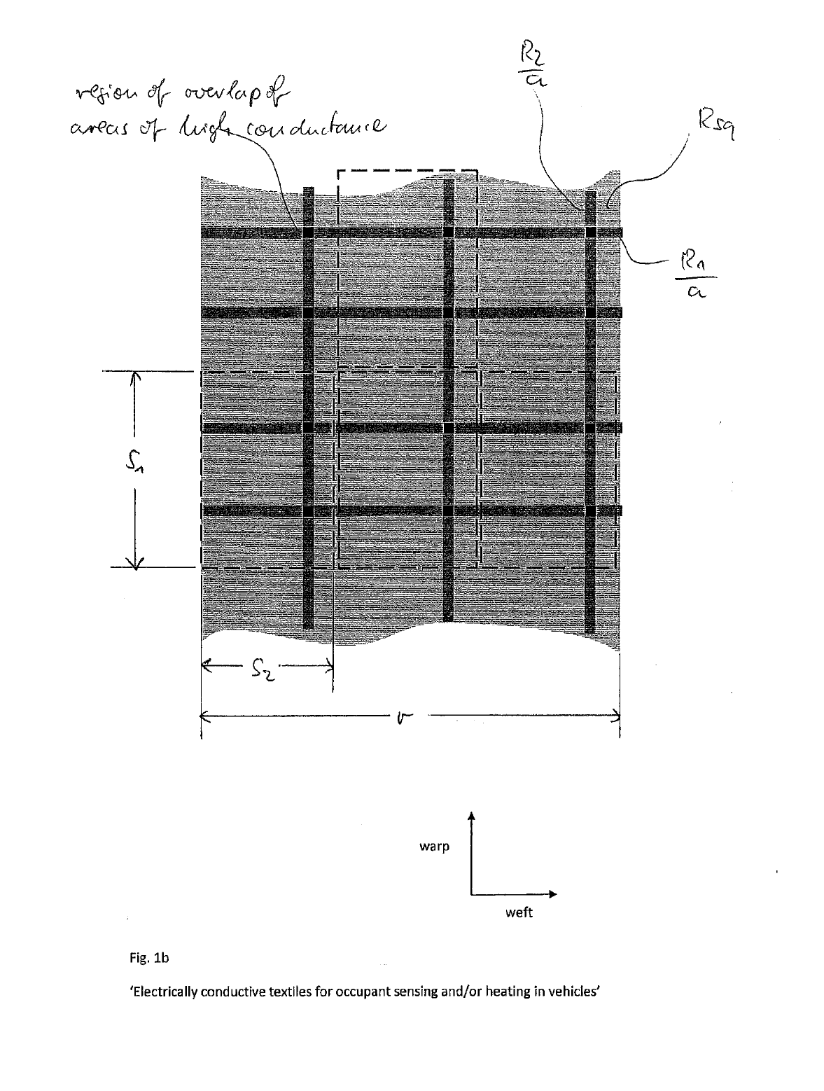

Let us first describe a textile electrode for a capacitive occupant classification (or detection) system the function of which is to ensure defined electrical potential over the electrode area in a typical frequency range between 10 kHz and 1 MHz. For this purpose the electrode needs to possess low impedance but its ampacity is allowed to be rather small. In order to minimize the consumption of expensive, high conductance textile and in order to maximize its mechanical robustness the sensor electrode is prepared of areas of two different conductances. Areas of high conductance in weft (warp) direction cross the areas of high conductance in warp (weft) direction so as to create a rectangular pattern of areas of high conductance as well as regions where the areas of high conductance in warp and weft are overlapping. Areas of high conductance and areas of low conductance are suited to define the electric potential all across the electrode textile and hence enable detection of occupants by a capacitive technique. See FIG. 1 for illustration.

In the following four different implementations are described.

Aa.) Areas of high conductance are implemented by high conductance yarns and optionally by a high density of threads. A number of directly neighbored threads can comprise high conductance yarns. For the areas of high conductance the same yarn or different yarns may be used in weft and in warp. Areas of low conductance are implemented by using high or low conductance yarn in weft and in warp. The yarn composition and the thread density are adjusted so as to yield a sheet resistance Rsq of the area of low conductance between 10 Ohm and 10 kOhm, typically. Sensing is implemented with such raw textile.

Ab.) The raw textile is an unstructured textile sheet material of low conductance. The built up of the area of low conductance is as described in implementation Aa.). Areas of high conductance are applied by screen printing with a high conductivity ink in a pattern as shown in FIG. 1.

Ac.) Areas of high conductance are implemented according to implementation Aa.). The other areas of the raw textile are made of non-conductive yarns yielding an Rsq>10⁶ Ohm. The raw textile is subsequently overprinted with low conductance ink, either with a full (unstructured) print or in a (structured) print pattern so as to achieve an area of low conductance with a sheet resistance of Rsqⱼ between 10 Ohm and 10 kOhm.

Ad.) i.) The raw textile according to implementation Aa.) and Ac.) is overprinted with high conductivity ink in the region where the areas of high conductance in warp and weft are overlapping. This reduces the contact resistance between crossing threads and in consequence allows for fast adjustment of the electrostatic potential across the sensor textile.

ii.) In addition the region where the sensor textile will be contacted is overprinted with high conductivity ink. This allows for lower contact resistance in the region of contacting. Contacting is preferably implemented by crimping, riveting, soldering, or gluing.

iii.) In another implementation the raw textile according to implementations 1a.) and 1c.) is additionally overprinted with high conductance ink in the complete areas of high conductance (see FIG. 1).

Preferred Production of Sensor Textile

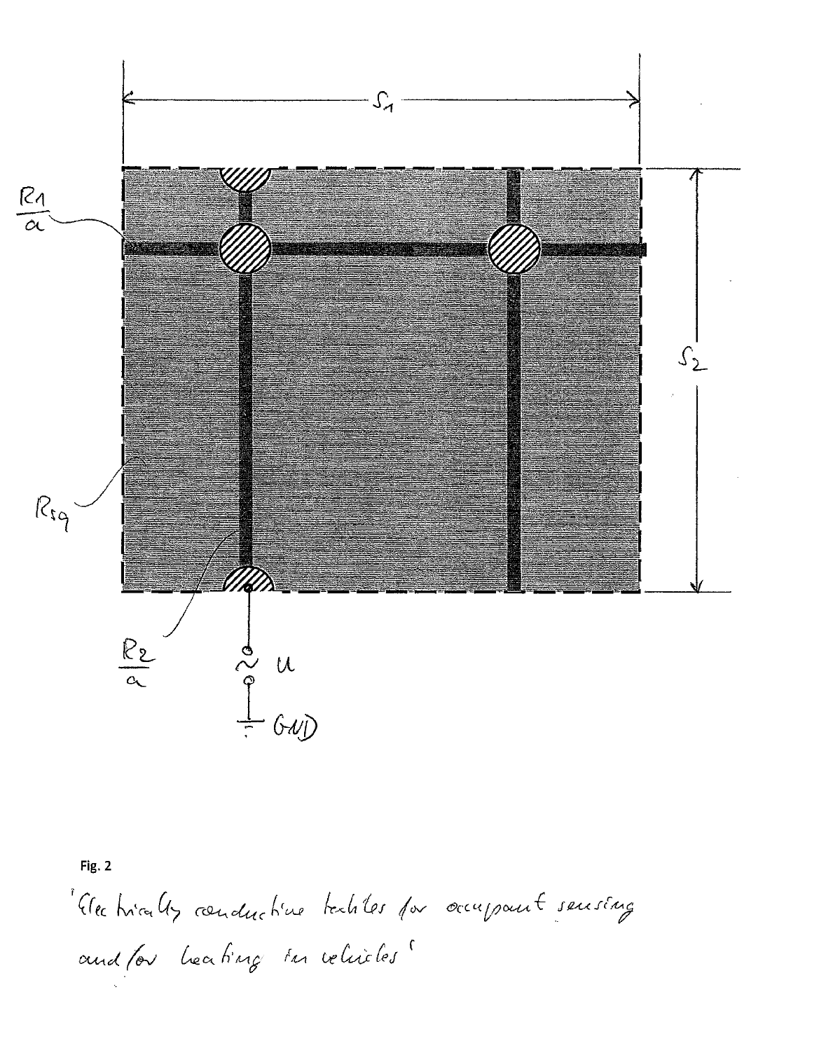

The raw textile is produced on roll in a weaving process. The raw textile is overprinted (implementations Ab.), Ac.), and Ad.)) preferably in flat bed or a rotary screen printing process. Typical sizes sₗ, s₂ of a sensor textile is between 200 and 400 mm for the length of each side. The corresponding side lengths of the sensor textile are denoted s₁ and s₂. In order to maximize roll usage the roll width r should be even integer multiples of the length s₁ of the sensor textile in case s₁ is measured in weft direction and integer multiples of the length s₂ of the sensor textile in case s₁ is measured in warp direction (see FIG. 2).

Spacing between neighbored areas of high conductance is either equal or alternates periodically between smaller and larger spacing in warp and in weft direction. Spacing or the alternating sequence may be different in warp and in weft direction and depends on the exact design of the textile electrode.

The raw textile (implementation Aa.)) or the printed textile (implementations Ab.), Ac.), and Ad.)) is cut from roll so as to obtain a textile electrode which can be contacted and integrated into a sensor. A schematic depiction of such a textile electrode is presented in FIG. 2.

B. Textile for heating or for heating and occupant classification or detection

Heating (Joule heating) requires an electric current flow. Typically the voltage is the on-board voltage of a vehicle. The heating current is defined by the voltage applied at a heating element and the electrical resistance of the heating element according to Ohm's law. The heating (=electric) power of the heating element is the product of applied voltage and electric current flowing through the heating element.

Voltage is not necessarily constant during operation. For heating the voltage may be a function of time; it may e.g. be pulse width modulated. Heating and occupant sensing base on the same textile material (this invention) but use different electronic control and power circuits. In this way the same areas of high conductance and areas of low conductance are used for heating and for occupant sensing but their functioning is different. As described above, heating needs an appreciable heating current in order to generate the required heating power whereas occupant sensing requires a fast definition of the electric potential on the textile electrode and very small currents. This can only be implemented with different electronic circuits that operate in an alternative, and typically periodic, sequence. The present invention also relates to a textile structure suitable to implement heating or heating and occupant sensing. The invention does not relate to electronic control circuits or power circuits that are not an integral part of the textile. A heater may comprise a multitude of differing heating elements.

### DEFINITIONS

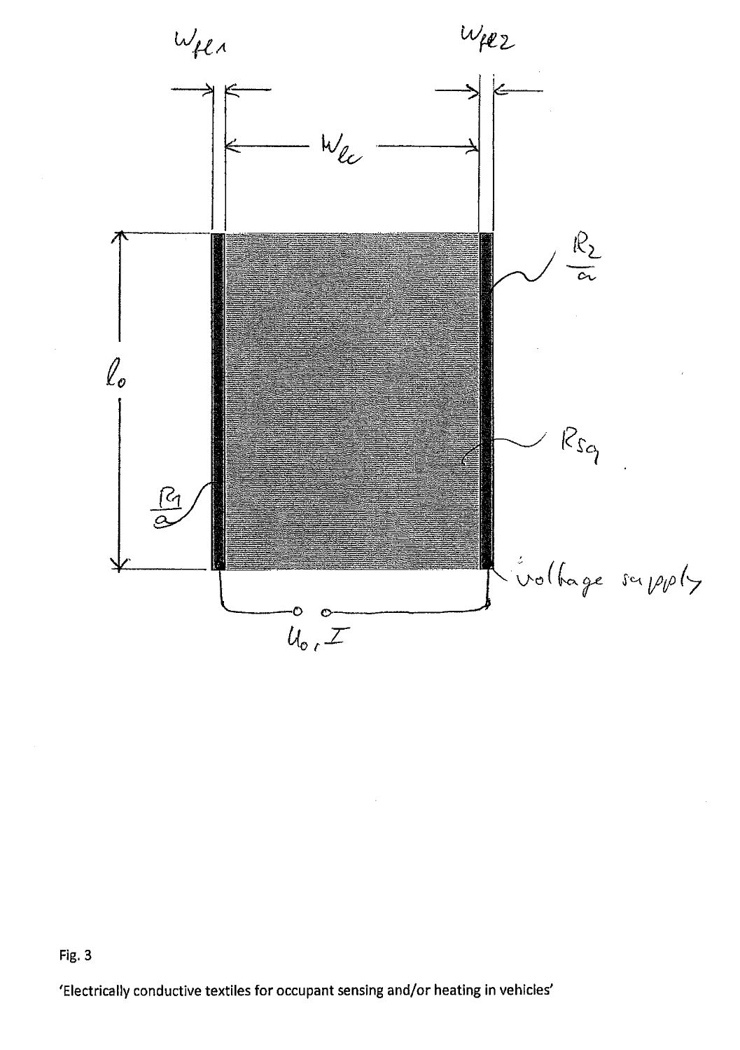

Power density: Heating power per area unit. The power density for a heater typically ranges from 100 to 1000 W/m².
Heating element: Functional element in a textile. It comprises two areas of high conductance in opposite to each other and an area of low conductance in between the opposing areas of high conductance. See FIG. 3 for illustration. Upon application of a voltage (=potential difference) between the areas of high conductance a heating current will flow through the area of low conductance. This principle of heating is generally known as parallel heating.
Feed line(s): Opposing areas of high conductance with an area of low conductance in between. Feed lines ‘feed’ the area of low conductance with current in order to heat up the area of low conductance.

In practice the electrical resistance of the feed lines of the heating element will lead to a voltage drop in the feed lines and accordingly to a heating current in the feed lines. As a direct consequence the heating power density in the heating element will not be constant but it will be a function of the distance from the voltage supply. Also, for equal distance from the voltage supply the power density will differ between the feed lines and the area of low conductance.

The width of the feed lines, w_{f/i}, i=1, 2, . . . —indexing the i-th feed line, is in general much smaller than the width of the area of low conductance, w_{/c} (say w_{/c}/=10). This is inherent to the concept of parallel heating. However, this is not a requirement, rather a note for the reader.

In order to render a textile heating element suitable for automotive applications several conditions need to be fulfilled. The meaning of variables is illustrated in FIG. 3. The two feed lines possess index i (i=1, 2); for the single area of low conductance (j=1) of width w_{/c} and Rsqᵢ=Rsq.

Condition 1: A certain power density needs to be achieved within a certain tolerance interval. Stationary temperature difference is proportional to the power density. The target power density of a heating element needs to be sufficiently high, 1.) in order to achieve a fast heating up at low environment temperature and, 2.) because the power density over the complete heater will in general be equal or lower than the power density of a single heating element. The targeted power density, P_{target}/A, of a heating element writes

$${ {P}_{i} target / A = ( \text{?} {0}^{t} 2 [ \text{?} 0 √ ( ( \text{?} + \text{?} ) / a ) ) √ ( Rsq \cdot \text{?} ) ] )}^{t} 2 + ( √ ( Rsq \cdot \text{?} ) Tanh [ ( \text{?} \\ \text{?} \text{indicates text missing or illegible when filed} \qquad ( Eq . 1 )$$

A typical tolerance interval on P_{target}/A is ±5%. Equation 1 provides an instruction how the conductive materials and how the geometrical dimensions need to be chosen in order to achieve a defined power density of the heating element. Typically, the supply voltage of the heating element, U₀, is given a priori, being either the on-board d.c. voltage or a lower voltage.

Condition 2: The power of a heating element of length l₀ is not allowed to drop more than a specified fraction from one end to the other end of the heating element. The power is a monotonically decreasing function of the distance from the voltage supply. The condition that the power density in the area of low conductance at length x=l₀ is not less than f₁ times (with f₁≦1) the power density at x=0 (where the voltage U0 is supplied) writes

$${( Sech [ \frac{{1}_{0}}{\sqrt{Rsq \cdot {w}_{1 c}}} \sqrt{\frac{{R}_{1} + {R}_{2}}{a}} ] )}^{2} \geq {f}_{1} \qquad ( Eq . 2 )$$

A typically chosen value is fₗ=0.95.

Condition 3: The power density of the feed lines, P_{f/i}, must not exceed the power density of the area of low conductance, P_{/c}, by a factor of f₃ in order to prevent too high temperature of the feed lines. On the other hand it is desirable that the feed lines also heat up to some extent (by a factor f₂) in order to homogenize the power density of the heater. For the ease of presentation we set Rᵢ=R and w_{f/i}=w_{fl} for all i. We thus demand that f₂<P_{f/i}P_{/c}<f₃ where P_{f/i} is the maximum power density of the feed line and P_{/c} is the maximum power density of the area of low conductance. Obviously the maximum power densities are achieved at x=0 (where the voltage U₀ is supplied). The condition for the power density of the feed lines ranging between f₂ and f₃ times the power density of the area of low conductance writes

$${f}_{2} \leq \frac{{{w}_{1 c} ( Tanh [ \frac{{l}_{0} \sqrt{\frac{2 R}{a}}}{\sqrt{Rsq \cdot {w}_{1 c}}} ] )}^{2}}{2 {w}_{f 1}} \leq {f}_{3} \qquad ( Eq . 3 )$$

Typical values for f₂ and f₃ are 0.1 and 0.5, respectively.

In general it is useful to know the total power of a heating element comprising the area of low conductance as well as two identical feed lines. The total power P of a heating element writes

$$P = \frac{{U}_{0}^{2} Tanh [ \frac{{l}_{0} \sqrt{\frac{2 R}{a}}}{\sqrt{Rsq \cdot {w}_{1 c}}} ]}{\sqrt{\frac{2 R}{a}} \sqrt{Rsq \cdot {w}_{1 c}}} \qquad ( Eq . 4 )$$

In the following we refer to the above formulated conditions as conditions 1 to 3.

A heating element (that can overtake occupant sensing function) is designed and built so as to fulfill conditions 1 to 3. Note that conditions 1 to 3 provide exact criteria for the choice of materials (Rᵢ/a, Rsq), the geometry of a heating element (w_{f/i}, w_{/c}, l₀), and thermo-electrical conditions (U₀, P_{target}/A). In practice some of the above named variables may be invariant and thus cannot be altered in order to best meet conditions 1 to 3.

In the following several implementations of a heating element are described. All implementations fulfill the above listed conditions 1 to 3. A heater is composed of one or of a multitude of heating elements. Heating elements may differ in material or geometry, but all heating elements fulfill conditions 1 to 3. Heaters and/or sensors are implemented either with a raw textile or with a printed textile. The presence of areas of high conductance and areas of low conductance allows the electric potential of the textile electrode to adjust quick enough in order to enable capacitive occupant sensing.

Implementations

Ba.) Areas of high conductance are implemented by high conductance yarns and optionally by a high density of threads either in weft or in warp. A number of directly neighbored threads can comprise high conductance yarns. Areas of low conductance are implemented by using high or low conductance yarn in weft and in warp. The yarn composition and the thread density are adjusted so as to yield a sheet resistance of the area of low conductance between 10 Ohm and a 10 kOhm, typically. Sensing and/or heating is implemented with such raw textile.

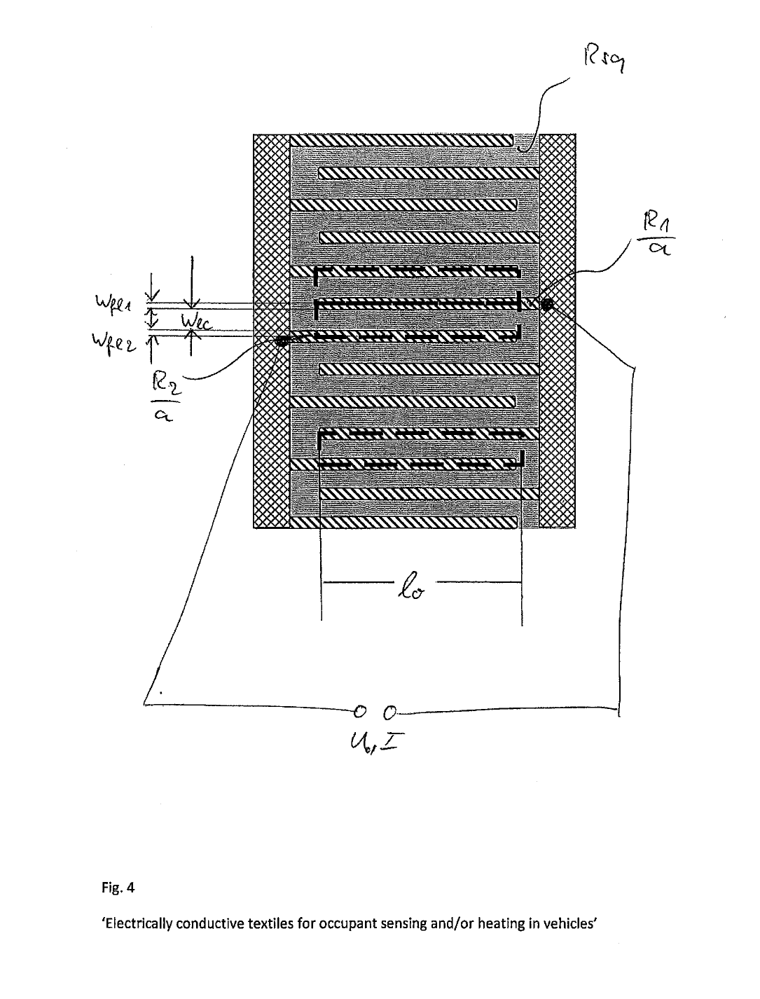

Bb.) The raw textile is an unstructured textile sheet material of low conductance as described in implementation Ba.). Areas of high conductance are applied by printing with a high conductance ink in a patterned manner. Since printing provides the freedom to structure the areas of high conductance in order to best meet the conditions 1 to 3, an implementation of a heater composed of multiple identical heating elements can look like is shown in FIG. 4.

Bc.) Areas of high conductance are woven as described in Ba.). The other areas of the raw textile are made of non-conductive yarn and possess a sheet resistance Rsq>10⁶ Ohm. This raw textile is subsequently overprinted with low conductivity ink, either with a full (unstructured) print or in a (structured) print pattern so as to achieve an area of low conductance with a sheet resistance of Rsq between 10 Ohm and 10 kOhm.

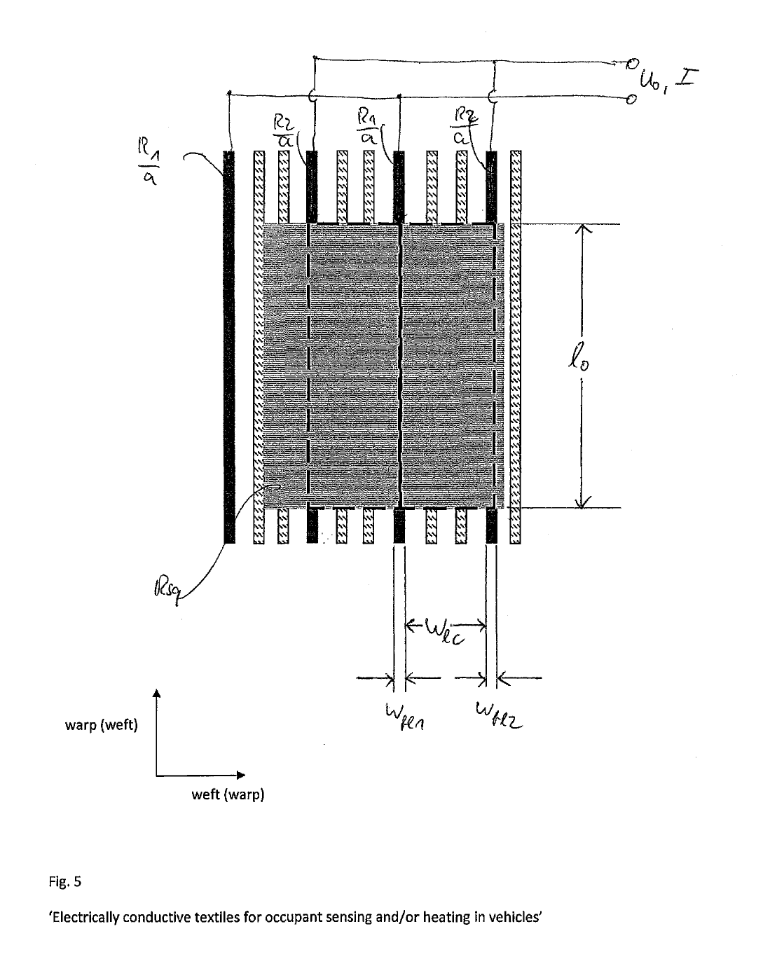

In a particular implementation the feed lines comprise single threads and voltage is applied across neighbored feed lines. In between neighbored feed lines there may be a number of non-conductive threads made of pure polymer yarn. FIG. 5 illustrates such a implementation where a heater is composed of multiple heating elements.

Bd.) An area of high conductance is woven according to implementation Ba.) and overprinted with high conductivity ink i.) so as to implement design Bb.), ii) in the region of electrical contacts (as was illustrated in FIG. 2), iii) in the complete areas of high conductance in order to minimize Rᵢ/a.

Further Features and Implementations for A (Sensing) and B (Sensing and/or Heating):

i.) An area of low conductance, characterized by sheet resistance Rsq, possesses anisotropic conductance properties. This means that the sheet resistance Rsq may possess different values as a function of the planar direction. In particular it is sufficient if Rsq possesses the values specified in the definition and in accord with conditions 1 to 3 in direction of the gradient of electric field only. In the perpendicular direction it is acceptable that Rsq>10⁶ Ohm. This means that in direction perpendicular to the electric field gradient, threads and yarns may be non-conductive, being purely polymeric, e.g.

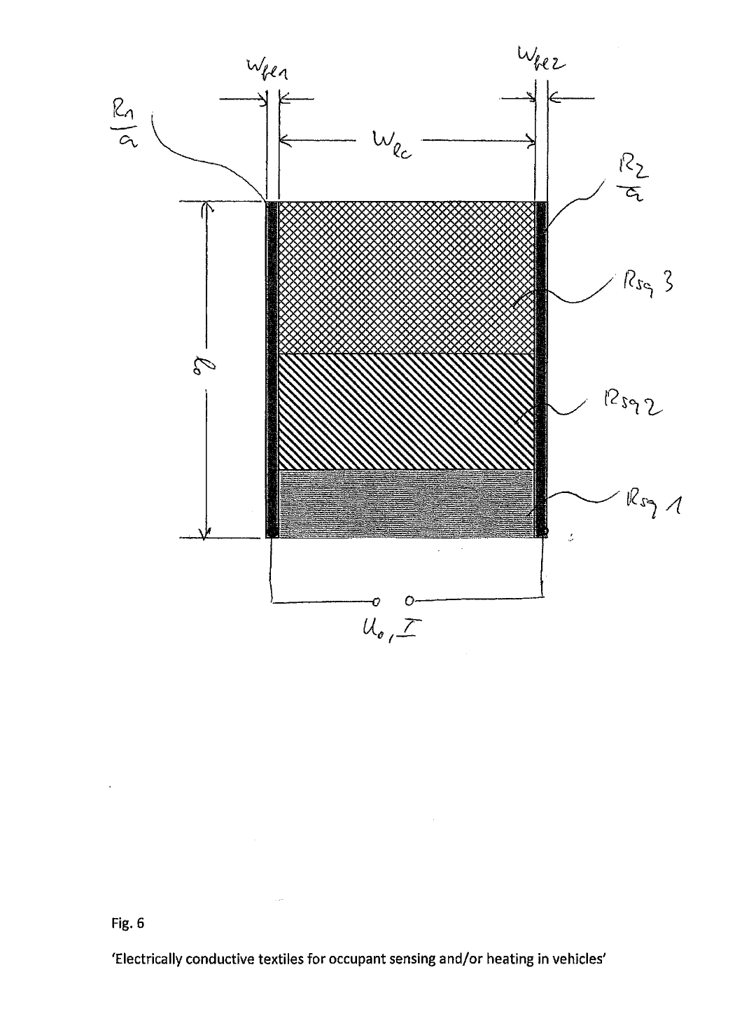

ii.) A heating element is composed of multiple areas of low conductance of different Rsqⱼ. Preferably the Rsqⱼ of an area of low conductance is the lower, the greater the distance to the voltage supply is. In case of j areas of low conductance the respective sheet resistance of the j-th area shall be Rsq. In this way it is easier to fulfill conditions 1 to 3, in particular if geometrical constraints are imposed on the heating element. As an example FIG. 6 shows a heating element with three (j=1, 2, 3) areas of width wₖ of low conductance of different Rsq. In particular, Rsqᵢ can be implemented by the raw textile whereas the lower Rsq₂ and Rsq₃ are implemented by printing the respective areas with low conductivity ink on the raw textile. Rsq₃ can be achieved by printing a higher mass per area unit of conductive ink, e.g., or by printing an ink of higher conductivity.

iii.) Printing areas of high conductance where Rᵢ/a is not constant but varies as a function of the distance from the voltage supply. Aim is to enable the fulfillment of conditions 1 to 3. This is preferably implemented by selectively overprinting parts of the areas of high conductance in the raw textile with high conductivity ink.

iv.) The heater textile and/or sensor textile integrated in a vehicle may comprise a multitude of heating elements. FIGS. 4 and 5 present examples where a heater is composed of multiple heating elements. It is self-understanding that a feed line feeding more than one heating element will carry an accordingly higher electric current. This needs to be considered in the evaluation of conditions 1 to 3.

v.) In case that the heater is composed of more than one heating element the material properties (Rᵢ/a, Rsqⱼ) and the geometrical parameters of the heating elements may be chosen differently for the various heating elements.

vi.) In case that a heater is composed of a multitude of (potentially different) heating elements, the fulfillment of conditions 1 to 3 is preferably supported by the use of appropriate computer simulation techniques.

FIG. 1a.) and 1b.) show an embodiment of the raw textile in top view. The schematic presentation of FIG. 1a.) or 1b.) displays a textile section that extends across the complete width of the roll (weft direction) and an arbitrary section in warp direction. Light gray areas indicate areas of low conductance of sheet resistance Rsq whereas the dark gray stripes in weft and warp indicate areas of high conductance of resistance per length unit Rᵢ/a and R₂/a, respectively. The sequence of spacings between neighbored areas of high conductance is periodic, in weft as well as in warp. Black squares indicate the regions where weft and warp areas of high conductance overlap. The figures refer to implementations Aa.), Ab.), and Ac.).

FIG. 1a.) exemplifies three textile electrodes indicated by dashed bordered rectangles. Their extension in weft direction is s₁, its extension in warp direction is s₂. The roll width is integer multiples of s₁. In the present example the roll width, r, is two times s₁. These textile electrodes are cut out of the textile roll in a way that the U-shape areas of high conductance lie in warp direction (the opening of the U).

FIG. 1 b.) exemplifies an alternative implementation where the periodic sequence of areas of high conductance is reversed, i.e. warp and weft are exchanged compared to FIG. 1a.). The four textile electrodes are indicated by the dashed rectangles. Let us denote their extension in warp direction with Sᵢ and in weft direction with s₂. The roll width is integers multiples of s₂. In the present example the roll width r is three times s₂. These textile electrodes are cut out of the textile roll in a way that the U-shape areas of high conductance lie in weft direction (the opening of the U).

FIG. 2 is a schematic top view of the textile electrode made of printed textile. The displayed textile electrode corresponds to the dashed rectangle in FIG. 1a.) with the extension s₁ (horizontal) and s₂ (vertical). Light gray areas indicate areas of low conductance of sheet resistance Rsq whereas the dark gray stripes in weft and warp indicate areas of high conductance of resistance per length unit Rita and R₂/a, respectively. Dashed circles and half circles indicate overprints with high conductivity ink in the regions where the areas of high conductance overlap (as described in implementation Ad.)i.)) and in region where the voltage supply is contacted according to implementation Ad.)ii.). The areas of high conductance form a U-shape. The textile electrode is contacted to a simplified electrical circuit.

FIG. 3 shows a schematic heating element in top view where the area of low conductance is displayed in light gray, the areas of high conductance, the so-called feed lines, are shown in dark gray color. The length of the heater element is l₀, the area of low conductance (sheet resistance Rsq) possesses the width w_{/c}, and the widths of the two areas of high conductance are w_{f/1} and w_{f/2}, possessing resistance per unit length R_{1/a} and R_{2/a}, respectively. Voltage is applied between the bottom ends of the areas of high conductance defining the position of voltage supply. A current flows through the voltage source from one area of high conductance through the area of low conductance to the other area of high conductance.

FIG. 4 is a schematic top view illustration of multiple heating elements. The gray area indicates the area of low conductance provided by the raw textile. The hatched area is the area of high conductance. The area of high conductance is printed on the raw textile. The displayed section of a heater comprises multiple heating elements, three of which are arbitrarily chosen are highlighted by rectangles with dashed borderline. In this presentation the geometry and the materials involved are identical for the three heating elements. In general, geometry and materials can be chosen differently for different heating elements. In any case each heating element fulfills conditions 1 to 3. The cross-hatched areas are also areas of high conductance; typically the conductance of the cross-hatched areas is greater than that of the hatched areas. They can be implemented by overprinting areas of high conductance that are already implemented in the raw textile, with high conductivity ink. In engineering practice one may wish to design the heater geometry with the help of finite element simulation. The voltage supply may be contacted wherever desired. In practice one will contact the heater at appropriate positions in the two cross-hatched areas of high conductance.

FIG. 5 shows a section of a weave in top view showing high conductance threads implemented by high conductance yarn (dark gray lines) and non-conductive threads implemented by non-conductive, pure polymer yarn (hatched lines). In this figure the threads shown lie either in warp or in weft direction. For clarity threads lying in perpendicular direction (weft or warp, respectively), are not shown. Such threads are also made from non-conductive yarn. In the afore defined terminology the dark gray lines represent the areas of high conductance. Areas of low conductance are implemented by overprinting the raw textile with low conductivity ink. In the figure such an area of low conductance is shown in light gray. The rectangles with dashed borderline represent heating elements that fulfill conditions 1 to 3. A heater may be composed of a high number of such heating elements. Note that the lateral extension of the heater is defined essentially by the printed area of low conductance. The voltage supply is contacted to the areas of high conductance so that the electric potential alternates between neighbored areas of high conductance. A bus system is used for contacting so that the voltage applied across each heating element is well defined.

FIG. 6 shows a heating element comprising two areas of high conductance (feed lines) colored in dark gray. Three areas of low conductance (j=1, 2, 3) of width w_{/c} and of sheet resistance Rsqⱼ, are colored in light gray, hatched, and cross-hatched, respectively.

1.-15. (canceled)

16. Flexible heater and/or electrode comprising a woven textile material having a warp direction and a weft direction, said textile material comprising at least one region having a low electrical conductance and at least two regions having a high electrical conductance, said at least two regions of high electrical conductance being adjacent to said at least one region of low electrical conductance, wherein a first one of said at least two regions of high electrical conductance extends in warp direction adjacent at least one region having a low electrical conductance and wherein a second one of said at least two regions of high electrical conductance extends in weft direction adjacent at least one region having a low electrical conductance, said first one and said second one of said at least two regions of high electrical conductance intersecting at least in one crossing point, and wherein at least one of said at least two regions of high electrical conductance is operatively connected to a connection terminal of said heater and/or electrode, said connection terminal for connecting said heater and/or electrode to an electronic control circuit.

17. Flexible heater and/or electrode according to claim 16, wherein said at least one region having a low electrical conductance is provided by the use of electrically conductive weft and/or warp yarns in a suitable thread density.

18. Flexible heater and/or electrode according to claim 16, wherein said at least one region having a low electrical conductance is provided by applying, preferably printing, a low conductivity material onto a woven textile made of non-conductive yarns or of low conductance yarns.

19. Flexible heater and/or electrode according to claim 16, wherein at least one of said at least two regions of high electrical conductance is provided by the use of high conductance weft or warp yarns.

20. Flexible heater and/or electrode according to claim 16, wherein at least one of said at least two regions of high electrical conductance is provided by applying, preferably printing, a high conductivity material adjacent to said at least one region having a low electrical conductance onto a woven textile made of non-conductive yarns or of low conductance yarns.

21. Flexible heater and/or electrode according to claim 16, wherein high conductivity material is applied, preferably printed, onto said first one and said second one of said at least two regions of high electrical conductance in the area of said crossing point.

22. Flexible heater and/or electrode according to claim 16, wherein said at least one region having a low electrical conductance is configured to have anisotropic conductance properties, preferably different electronic properties in weft and warp directions.

23. Flexible heater and/or electrode comprising a woven textile material having a warp direction and a weft direction, said textile material comprising at least one region having a low electrical conductance and at least two regions having a high electrical conductance, said at least two regions of high electrical conductance being adjacent to said at least one region of low electrical conductance, wherein a first one and a second one of said at least two regions of high electrical conductance both extend in warp direction or in weft direction adjacent opposing sides of said at least one region having a low electrical conductance and wherein both the first one and the second one of said at least two regions of high electrical conductance are operatively connected to connection terminals of said heater and/or electrode, said connection terminals for connecting said heater and/or electrode to an electronic control circuit.

24. Flexible heater and/or electrode according to claim 23, wherein said at least one region having a low electrical conductance is provided by the use of electrically conductive weft and/or warp yarns in a suitable thread density.

25. Flexible heater and/or electrode according to claim 23, wherein said at least one region having a low electrical conductance is provided by applying, preferably printing, a low conductivity material onto a woven textile made of non-conductive yarns or of low conductance yarns.

26. Flexible heater and/or electrode according to claim 23, wherein at least one of said at least two regions of high electrical conductance is provided by the use of high conductance weft or warp yarns.

27. Flexible heater and/or electrode according to claim 23, wherein at least one of said at least two regions of high electrical conductance is provided by applying, preferably printing, a high conductivity material adjacent to said at least one region having a low electrical conductance onto a woven textile made of non-conductive yarns or of low conductance yarns.

28. Flexible heater and/or electrode according to claim 23, wherein high conductivity material is applied, preferably printed, onto said first one and said second one of said at least two regions of high electrical conductance in the area of said crossing point.

29. Flexible heater and/or electrode according to claim 23, wherein said at least one region having a low electrical conductance is configured to have anisotropic conductance properties, preferably different electronic properties in weft and warp directions.

30. Heating installation comprising a number of heater elements and an electronic control unit for supplying said heater elements with a heating current, each of said heater elements comprising a flexible heater and/or electrode according to claim 16.

31. Heating installation according to claim 30, wherein the regions of low electrical conductance of the individual heater elements have different electrical properties, such as different sheet resistance Rsqⱼ.

32. Heating installation according to claim 31, wherein the individual heater elements are arranged in a sequence in such a way that the individual sheet resistances Rsqⱼ of the regions of low conductance decrease with increasing distance from said connection terminal.

33. Heating installation according to claim 30, wherein the respective ones of the at least two regions of high electrical conductance of the individual heater elements are arranged in mutual alignment and interconnected so as to form a common feed line for the individual regions of low conductance.

34. Heating installation comprising a number of heater elements and an electronic control unit for supplying said heater elements with a heating current, each of said heater elements comprising a flexible heater and/or electrode according to claim 23.

35. Heating installation according to claim 34, wherein the regions of low electrical conductance of the individual heater elements have different electrical properties, such as different sheet resistance Rsqⱼ.

36. Heating installation according to claim 35, wherein the individual heater elements are arranged in a sequence in such a way that the individual sheet resistances Rsqⱼ of the regions of low conductance decrease with increasing distance from said connection terminal.

37. Heating installation according to claim 34, wherein the respective ones of the at least two regions of high electrical conductance of the individual heater elements are arranged in mutual alignment and interconnected so as to form a common feed line for the individual regions of low conductance.

38. Sensing installation comprising a flexible heater and/or electrode according to claim 16, and an electronic control unit for supplying said flexible heater and/or electrode with a sensing voltage or current.
